(19) United States
(12) Patent Application Publication
(10) Pub. No.: US 2015/0153468 A1
(43) Pub. Date: Jun. 4, 2015

(54) SYSTEM AND METHOD FOR IDENTIFYING SUBSURFACE DISCONTINUITIES FROM SEISMIC DATA

(71) Applicants: Karl Philip Boles, Paradise, CA (US); Ashok Kumar Sen, Houston, TX (US); Jeremy John Zimmerman, Houston, TX (US)

(72) Inventors: Karl Philip Boles, Paradise, CA (US); Ashok Kumar Sen, Houston, TX (US); Jeremy John Zimmerman, Houston, TX (US)

(73) Assignee: CHEVRON U.S.A. INC., San Ramon, CA (US)

(21) Appl. No.: 14/094,980

(22) Filed: Dec. 3, 2013

(51) Int. Cl. G01V 1/36

(52) U.S. Cl. CPC G01V 1/36

(57) ABSTRACT

Embodiments of a system and method for identifying discontinuities in a subsurface volume of interest are disclosed herein. Embodiments utilize analysis of azimuthal variations in trim statics corrections calculated on offset groups of flattened CDP gathers to identify discontinuities.

### FIELD OF THE INVENTION

The present invention relates generally to methods and systems for processing seismic data and, in particular, identifying discontinuities in the earth's subsurface based on seismic data.

### BACKGROUND OF THE INVENTION

Exploration for and development of hydrocarbon reservoirs may be efficiently done with the help of seismic data, which must be properly processed in order to allow interpretation of subsurface features. Generally, seismic data is acquired by using active seismic sources to inject seismic energy into the subsurface which is then refracted and/or reflected by subsurface features and recorded at seismic receivers.

As seismic energy passes through the subsurface, the speed of the seismic wavefront varies as it encounters formations with different rock properties (e.g. density, fluid saturation, mineralogy, fracturing). In some cases, the rock properties will allow the seismic energy to propagate at different speeds in different directions. This is known as seismic anisotropy. Conventional methods for identifying seismic anisotropy generally involve velocity analysis and are thus computationally expensive.

There is a need for simple, computationally inexpensive methods and systems for identifying seismic anisotropy which may be used to identify subsurface discontinuities such as faults and fractures.

### SUMMARY OF THE INVENTION

Described herein are implementations of various approaches for a computer-implemented method for identifying subsurface discontinuities based on seismic data.

A computer-implemented method for identifying discontinuities in a subsurface volume of interest including the operations of receiving a full-azimuth seismic dataset, wherein the full-azimuth seismic dataset includes flattened common depth point (CDP) gathers; sorting the CDP gathers into offset groups; calculating trim statics corrections for each of the offset groups within a time or depth interval of interest; and identifying discontinuities based on a particular azimuth set associated with the trim statics corrections is disclosed.

In another embodiment, a computer system including a data source or storage device, at least one computer processor and a user interface used to implement the method for identifying discontinuities in a subsurface volume of interest is disclosed.

In yet another embodiment, an article of manufacture including a computer readable medium having computer readable code on it, the computer readable code being configured to implement a method for identifying discontinuities in a subsurface volume of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 shows an intermediate step of an embodiment of the present invention;

FIG. 3 shows another intermediate step of an embodiment of the present invention;

FIG. 4 shows a result of an embodiment of the present invention;

FIG. 5 shows another result of an embodiment of the present invention; and

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

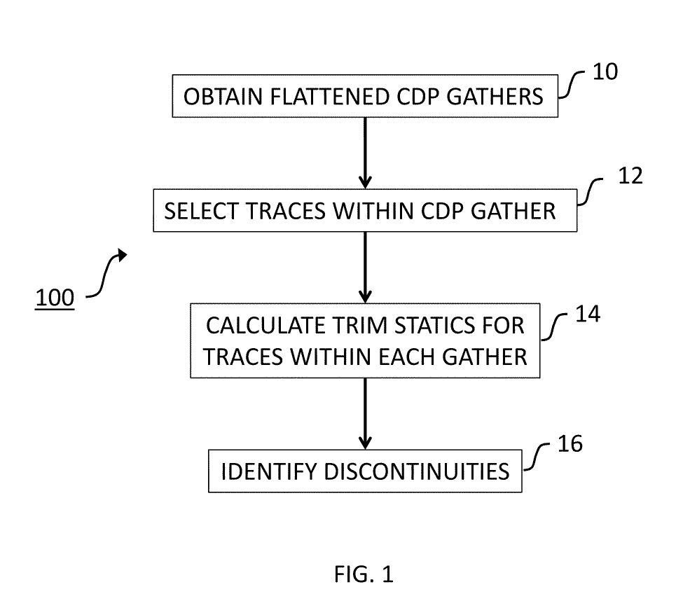

The present invention relates to identifying subsurface discontinuities based on seismic data. One embodiment of the present invention is shown as method 100 in FIG. 1. At operation 10, a seismic dataset with a wide range of azimuths is obtained. The seismic dataset is representative of the way that seismic energy propagated through a subsurface volume of interest. In one embodiment, it may be a full-azimuth land dataset, meaning that it was acquired with sources and receivers positioned on land such that seismic energy was transmitted and received from all directions. In an embodiment, the seismic data may have been processed using a depth migration algorithm. The seismic dataset may be arranged in common depth point (CDP) gathers, which may be substantially flat. Common-depth point gathers are used to give a more accurate location of any anomalies. The information regarding the azimuth information for each trace in the gather is retained. This may be the result of direction sorting or migrations in the form of common-offset vector processes.

Flattened CDP gathers generally indicate that the seismic dataset has been migrated using a reasonably accurate seismic velocity model. However, in practice the seismic velocity model is a best estimate which may not account for factors such as azimuthal anisotropy. Azimuthal anisotropy in the rock formations of the subsurface volume of interest may occur for a variety of reasons including lithology, such as shale, and fracturing. Differences in this anisotropy of the subsurface in adjacent rock bodies can be an indication of faulting.

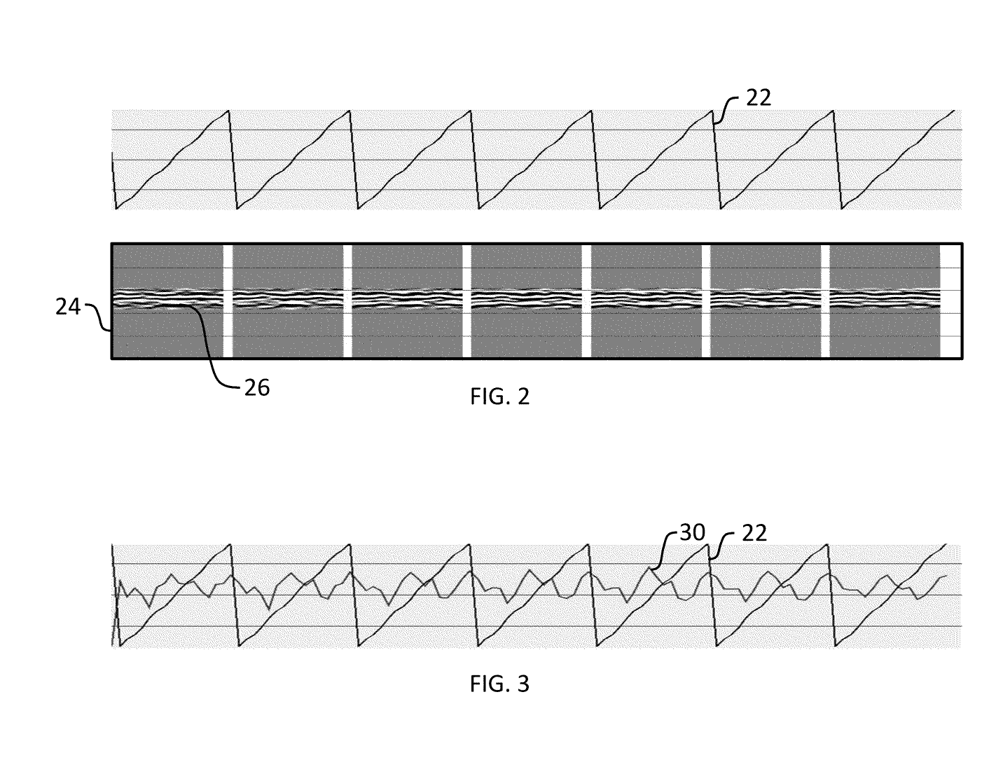

FIG. 2 shows seven flattened CDP gathers (panel 24) for a single offset with their azimuths indicated as line 22. The azimuths indicate full azimuthal coverage from −180 degrees to +180 degrees. The seismic events in the flattened CDP gathers 24 are reasonably flat and continuous. The small deviation from flatness 26 (commonly called a residual) is a possible indicator of anisotropy.

Referring again to FIG. 1, the traces within a CDP gather are selected at operation 12 based on a desired offset range from source to receiver. This offset range is selected based on sensitivity to azimuthal velocity variations and full population of the number of traces to bolster the statistical analysis.

Trim statics are calculated for all of the traces within each gather for an interval of interest at operation 14. This interval of interest may be a time or depth range around a seismic event that is believed to be representative of a hydrocarbon reservoir. The trim statics corrections are calculated to align the event of interest across all traces in the azimuth group, by cross-correlating the traces within a gather against a user-defined pilot trace. FIG. 3 shows trim statics corrections 30 along with the azimuths 22 for the flattened CDP gathers in FIG. 2.

Once the trim statics corrections have been calculated for each of the traces within a gather, they are compared to identify discontinuities at operation 16 of FIG. 1. The trace with the largest positive trim static correction may be termed the “fast” azimuth, as the large correction may indicate that there is a high velocity in that direction. The azimuth with the smallest trim static correction may be termed the “slow” azimuth. In an embodiment, the slow azimuth may be indicated by a negative trim static correction.

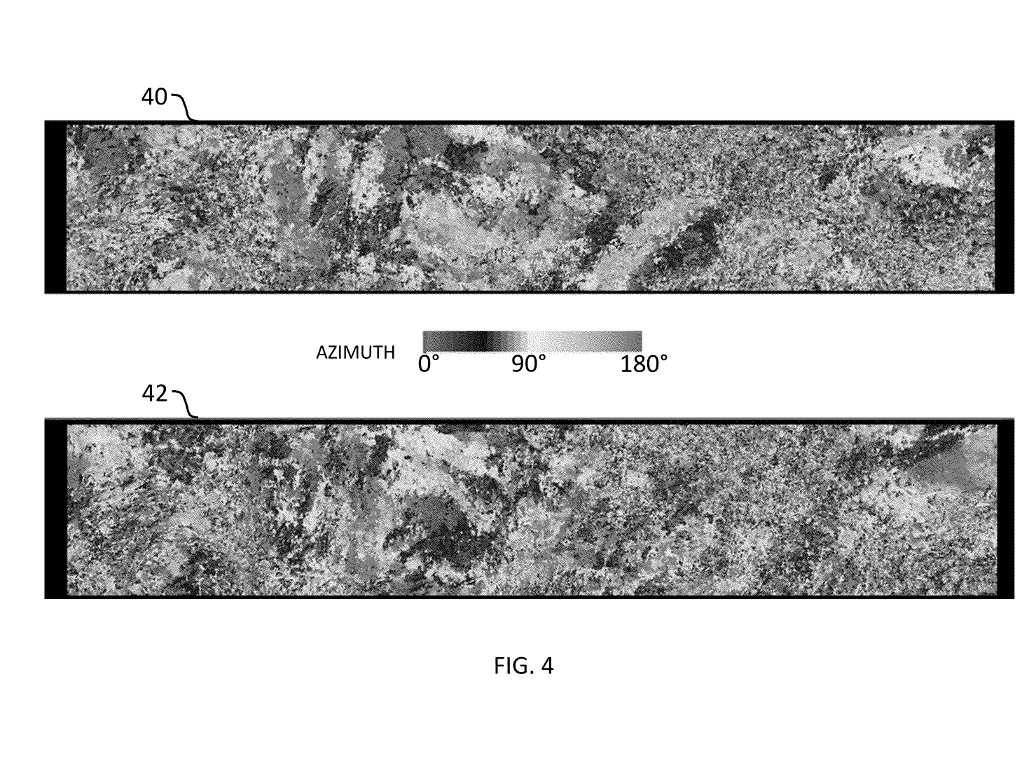

The method for determining the fast azimuth and slow azimuth is performed for each CDP location based on a given offset range. An example of a map of the fast azimuths may be seen in FIG. 4 as panel 40. The corresponding map of slow azimuths is shown as panel 42. The azimuth color bar is also shown. Note that reciprocal azimuth values are given the same color (i.e. −90 degrees is the same color as +90 degrees).

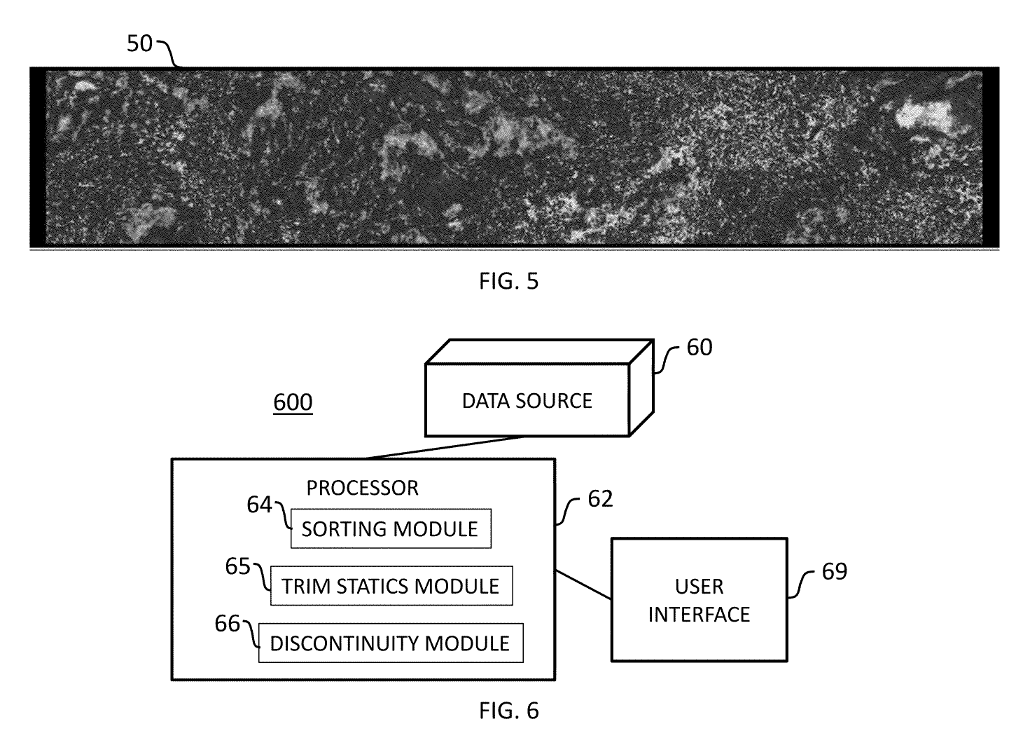

FIG. 5 shows the relative magnitude between the slow and fast azimuth trim static corrections (panel 50). Areas with large differences (shown as lighter areas here) may be interpreted to have larger anisotropy than the other areas that appear in darker colors. In some instances, larger anisotropy may indicate fractured formations that should be avoided when drilling wells, or as a potential target where the fracturing would improve fluid flow. The presence of azimuthal anisotropy is also a potential indicator of differential stresses on an interval, which can lead to preferential orientation of induced fracturing. Comparing the magnitudes of FIG. 5 with the slow and fast azimuth directions of FIG. 4 may allow interpretation of the anisotropy of the subsurface.

Although the embodiment of the invention shown in FIG. 1 illustrates the operations being performed in a particular sequence, this is not meant to be limiting. Some operations may be performed in parallel or in a different order. Other processing algorithms may also be included at various points in the workflow.

A system 600 for performing the method 100 of FIG. 1 is schematically illustrated in FIG. 6. The system includes a data source/storage device 60 which may include, among others, a data storage device or computer memory. The data source/storage device 60 may contain recorded seismic data or synthetic seismic data. The data from data source/storage device 60 may be made available to a processor 62, such as a programmable general purpose computer. The processor 62 is configured to execute computer modules that implement method 100. These computer modules may include a sorting module 64 for selecting traces within a desired offset range from the flattened CDP gathers; a trim statics module 65 for calculating the trim statics corrections of the traces; and a discontinuity module 66 for identifying the discontinuities. These modules may include other functionality. In addition, other modules such as a migration module to create the flattened CDP gathers may be used. The system may include interface components such as user interface 69. The user interface 69 may be used both to display data and processed data products and to allow the user to select among options for implementing aspects of the method. By way of example and not limitation, the input seismic data and/or the discontinuities computed on the processor 62 may be displayed on the user interface 69, stored on the data storage device or memory 60, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for identifying discontinuities in a subsurface volume of interest, the method comprising:
a. receiving, at a computer processor, a full-azimuth seismic dataset, wherein the full-azimuth seismic dataset includes flattened common depth point (CDP) gathers;
b. sorting, via the computer processor, the CDP gathers into offset groups;
c. calculating, via the computer processor, trim statics corrections for each of the offset groups within a time or depth interval of interest; and
d. identifying discontinuities based on a particular azimuth set associated with the trim statics corrections.

2. The method of claim 1 further comprising identifying a lowest and a highest statics shift value, wherein the particular azimuth set containing the lowest statics shift value is representative of a slow velocity direction and the particular azimuth set containing the highest statics shift value is representative of a high velocity direction.

3. The method of claim 2 wherein the slow velocity direction and the high velocity direction indicate azimuthal anisotropy.

4. The method of claim 2 further comprising graphically visualizing the slow velocity direction or the high velocity direction.

5. The method of claim 2 wherein the identifying discontinuities is performed by comparing geographical changes in the slow velocity direction or the high velocity direction.

6. The method of claim 2 further comprising calculating a relative magnitude difference between the lowest and the highest statics shift value.

7. The method of claim 1 further comprising interpreting faults or fractures in the subsurface volume of interest based on the discontinuities.

8. A system for identifying discontinuities in a subsurface volume of interest, the system comprising:
a. a data source containing full-azimuth seismic data representative of the subsurface volume of interest wherein the full-azimuth seismic data includes flattened common depth point (CDP) gathers;
b. a computer processor configured to execute computer modules, the computer modules comprising:
i. a sorting module for sorting the flattened CDP gathers into offset groups;
ii. a trim statics module for calculating trim statics for each of the offset groups; and
iii. a discontinuity module for identifying discontinuities; and
c. an user interface.

9. An article of manufacture including a computer readable medium having computer readable code on it, the computer readable code being configured to implement a method for identifying discontinuities in a subsurface volume of interest, the method comprising:
a. receiving a full-azimuth seismic dataset, wherein the full-azimuth seismic dataset includes flattened common depth point (CDP) gathers;
b. sorting the CDP gathers into offset groups;
c. calculating trim statics corrections for each of the offset groups within a time or depth interval of interest; and
d. identifying discontinuities based on a particular azimuth set associated with the trim statics corrections.
